(19) United States
(12) Patent Application Publication
(10) Pub. No.: US 2003/0061016 A1
(43) Pub. Date: Mar. 27, 2003

(54) Switching vector generation for electrical circuits

(76) Inventors: David T. Blaauw, Austin, TX (US); Supamas Sirichotiyakul, Austin, TX (US); Chanhee Oh, Cibolo, TX (US); Rafi Levy, Tel-Aviv (IL); Vladimir P. Zolotov, Cedar Park, TX (US)

Correspondence Address: MOTOROLA INC, AUSTIN INTELLECTUAL PROPERTY, LAW SECTION, 7700 WEST PARMER LANE MD: TX32/PL02, AUSTIN, TX, 78729

(21) Appl. No.: 09/942,166

(22) Filed: Aug. 29, 2001

(51) Int. Cl. G06F 17/50

(52) U.S. Cl. 703/14

(57) ABSTRACT

Method for generating a set of switching vectors where each vector S1-Si causes the output X to transition in the predetermined way provided that the input A transitions in the selected way. This method may be used for any electrical circuit cluster, including the simple one illustrated in FIG. 3. This method handles any number of side inputs, gate clusters which have feedback within the gate cluster, and gate clusters which have internal nodes that may be in a third state other than a logic level one or a logic level zero (e.g. a high impedance state).

### FIELD OF THE INVENTION

This invention related generally to electrical circuits, and more specifically to switching vector generation for electrical circuits.

### RELATED ART

For circuit analysis tools, such as transistor level timing analysis, electrical rule checkers, noise analysis tools, etc. it is common to simulate a gate or a cluster of gates in a transistor level circuit simulator (e.g. SPICE). Using such tools it is often desirable that the output of the gate or cluster of gates transitions due to the switching of one specific input to the gate or cluster of gates. To obtain such a transition at the gate output, it is necessary to set the logic state of the other inputs (herein called side inputs) of the gate or gate cluster to a specific state that allows the output to switch. For simple gates such as NAND or NOR gates this is a trivial task because all side inputs of a NAND or NOR gate need to be set to a logical level one (1) or a logic level zero (0). However, for more complicated circuit structures this may be a non-trivial task. Also, the state of the side inputs may affect the delay of the obtained transition of the output. Therefore it is usually necessary to find the complete set of side input states that result in a transition at the output. The term switching vector as used herein shall mean a set of side input states that produces a selected transition of the output as a result of a predetermined transition on one selected input.

Prior art techniques work relatively well for gates or gate clusters that are relatively simple. However as the number of side inputs increases, the number of possible side input states increases exponentially. For example if a circuit has N side inputs, then 2^{N} possible side input states must be examined. Thus for a gate cluster that has 20 side inputs, 2²⁰ or approximately 1 million possible side input states must be evaluated. In most cases such evaluation would be prohibitively time consuming.

Some prior art techniques do not enumerate all of the possible side input states, however these techniques do not work for gate clusters which have feedback within the gate cluster or which have internal nodes that may be in a third state other than a logic level one or a logic level zero (e.g. a high impedance state).

### BRIEF DESCRIPTION OF THE DRAWINGS

The present invention is illustrated by way of example and is not limited to the embodiments illustrated in the accompanying figures, in which like references may indicate similar elements.

FIG. 1 illustrates, in flow chart form, a portion of a method to generate switching vectors in accordance with one embodiment of the present invention;

FIG. 2 illustrates, in flow chart form, a portion of a method to generate switching vectors in accordance with one embodiment of the present invention; and

FIG. 3 illustrates, in schematic diagram form, a circuit for which switching vectors can be generated in accordance with one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements to help improve the understanding of the embodiments of the present invention.

### DETAILED DESCRIPTION

As used herein, the terms “assert” and “negate” are used when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

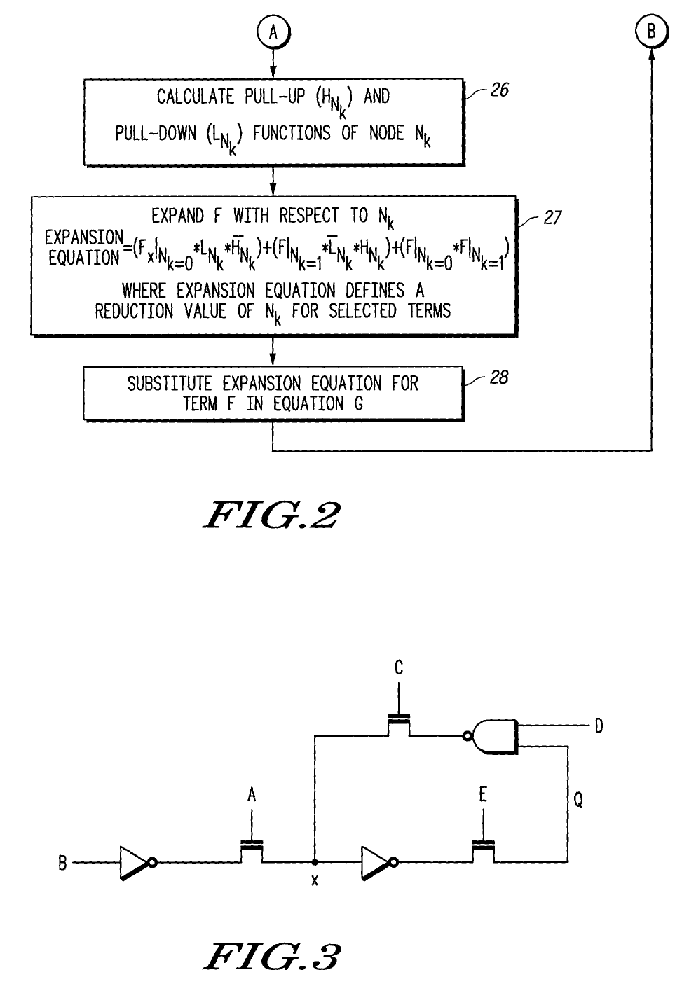

In one embodiment, the present invention provides a method for generating a set of switching vectors where each vector S₁-Sᵢ causes the output X to transition in the predetermined way provided that the input A transitions in the selected way. This method may be used for any electrical circuit cluster, including the simple one illustrated in FIG. 3. This method handles any number of side inputs, gate clusters which have feedback within the gate cluster, and gate clusters which have internal nodes that may be in a third state other than a logic level one or a logic level zero (e.g. a high impedance state).

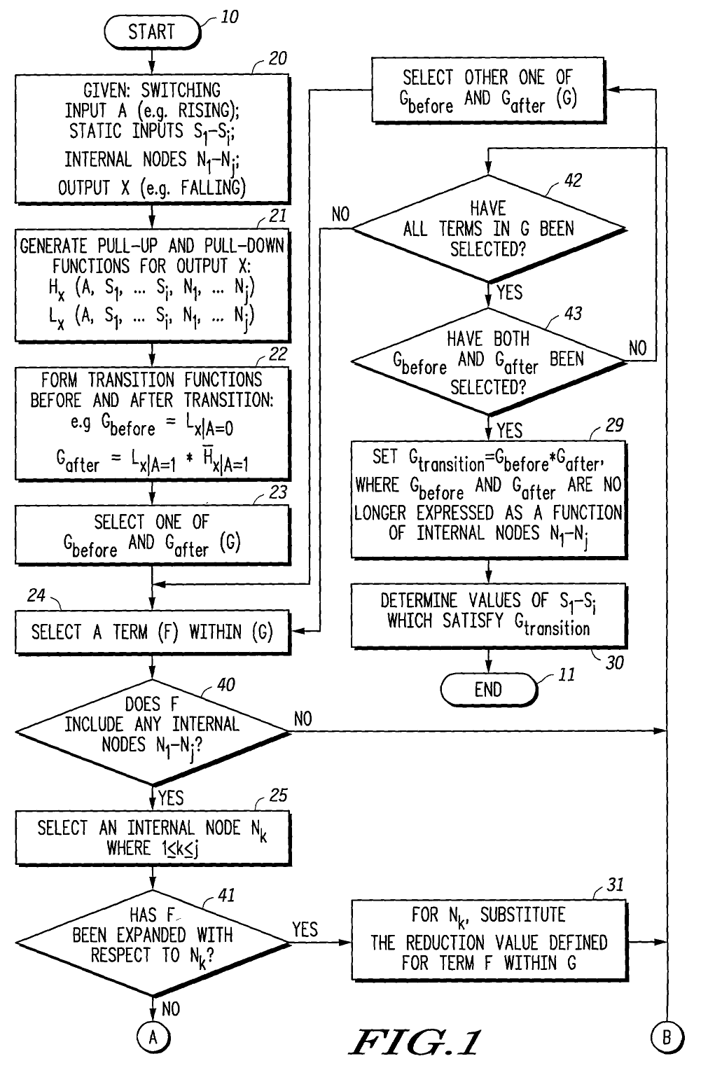

FIG. 1 and FIG. 2 illustrate one embodiment of a methodology which may be used to generate a set of switching vectors where each vector S₁-Sᵢ causes the output X to transition in the predetermined way provided that the input A transitions in the selected way. FIG. 1 starts at oval 10 and proceeds to rectangle 20 where the problem formulation is specified. In the example illustrated in FIG. 1, switching input A is selected to be rising, that means it is transitioning from a logic level 0 to a logic level 1. Also, static inputs S₁-Sᵢ are specified. Note that references will also be made to FIG. 3 where a circuit cluster is illustrated in order to show how the steps within the flow may be used to generate the switching vector for an actual circuit. Note however, that the present invention may be used for any circuit cluster, not just a simple circuit cluster such as the one illustrated in FIG. 3. Thus for FIG. 3, the static inputs S₁-Sᵢ are B, C, D, and E. Still referring to step 20, internal nodes N₁-Nⱼ are specified. In FIG. 3, Q is the only internal node. Referring again to step 20 in FIG. 1, the transition in output X that is of interest in the current example is a falling transition, that is a transition from a logic level 1 to a logic level 0. Note that the output in FIG. 3 is also labeled as X. The flow then proceeds from step 20 to step 21 where the pullup and pulldown functions for the output X are generated. The pullup function H_{X} is a Boolean function which specifies the states of inputs A, S₁-Sᵢ, and internal node states N₁-Nⱼ such that there is a path of conducting transistors from the output X to a power supply voltage (VDD). Referring again to FIG. 3, the pullup function H_{X} for the circuit of FIG. 3 can be defined by the following equation: H_{X}=A·\overline{B}+C·(\overline{D}+\overline{Q})=A·\overline{B}+C·\overline{D}+C·\overline{Q}. Referring again to step 21 in the flow of FIG. 1, the pulldown function L_{X} is a Boolean function which specifies the inputs A, S₁-Sᵢ, and internal nodes N₁-Nⱼ such that there is a path of conducting transistors from the output X to a power supply voltage (ground). Referring again to FIG. 3, the pulldown function L_{X} can be described by the following equation: L_{X}=A·B+C·D·Q. Following step 21, the flow then moves to step 22 where the transition functions are formed. In one embodiment of the present invention there are two transition functions, a transition function G before which represents the output state X before the selected transition (e.g. falling), and a transition function Gafter which represents the output X after the selected transition has occurred. In the example illustrated in step 22, Gbefore represents A=0 since the input to A is rising and has not transitioned to logic level 1, and also represents that the output X must not be a low state. In a similar manner the transition function Gafter may be defined as a combination of two functions ANDed together, both of which are defined when A=1 since A was defined to be rising and has now transitioned to a logic level 1. The first portion of Gafter requires that there be a conducting path between the output X and ground. The second portion of Gafter requires that there not be a conducting path between the output X and VDD. Referring now to FIG. 3, the Gbefore function can be described by the following equation:

$$Gbefore = \overline{{L}_{X}} {\vert}_{A = 0} = \overline{( A \cdot B + C \cdot D \cdot Q )} {\vert}_{A = 0} = \overline{C} {\vert}_{A = 0} + \overline{D} {\vert}_{A = 0} + \overline{Q} {\vert}_{A = 0} .$$

Similarly for FIG. 3 the Gafter equation can be represented by the following equation:

$$Gafter = {L}_{X} \cdot \overline{{H}_{X}} {\vert}_{A = 1} = ( A \cdot B + C \cdot D \cdot Q ) \overline{( A \cdot \overline{B} + C \cdot \overline{D} + C \cdot \overline{Q} )} {\vert}_{A = 1} = ( B \cdot C \cdot D + B \cdot \overline{C} \cdot \overline{Q} + B \cdot D \cdot \overline{Q} ) {\vert}_{A = 1}$$

. Note that the Gbefore represents the state of the output X before the input A has transitioned from a 0 to a 1, and the Gafter represents the output X after the input A has transitioned from a 0 to a 1. Note also that the output X was defined to be falling for this particular example; thus, Gbefore represents a logic level which is not low and Gafter represents a logic level which is low and not high. Note that alternate embodiments of the methodology may select different conditions for switching input A and output X. For example, switching input A may be falling instead of rising, and output X may be rising instead of falling. Similarly, Gbefore and Gafter may be defined in slightly different ways aside from those illustrated in step 22. For example, in an alternate embodiment Gbefore may be defined to be a state of output X which is not low and is high. The selected conditions for input A and output X are entirely up to the user of the methodology.

The flow now transitions from step 22 to step 23 where one of the transition functions Gbefore and Gafter is selected. Alternate embodiments of the present invention may select these transition functions in any order with the idea being that for most embodiments of the present invention, further processing of both Gbefore and Gafter will most likely be required. However, alternate embodiments of the present invention may only require further processing of one of Gbefore and Gafter. The flow then transitions from step 23 to step 24 where one term F within G is selected. Referring again to FIG. 3, in the example illustrated there, Gbefore was selected in step 23 and the term

$$\overline{Q} {\vert}_{A = 0}$$

was selected as the term F. The equation for F can thus be written as follows:

$$F = \overline{Q} {\vert}_{A = 0} .$$

A=0 indicates that this is the equation for Gbefore. Note that Q is an internal node. The flow then transitions from step 24 to decision diamond 40 which asks the question, does F include any internal nodes N₁-Nⱼ. If no, then the flow continues at the beginning of decision diamond 42. If yes, the flow then continues at step 25 where an internal node Nₖ is selected, where Nₖ is one of the nodes between N₁-Nⱼ inclusive. Referring to FIG. 3, the internal node Nₖ is node Q. The flow then continues from step 25 to decision diamond 41 where the question is asked, has F been expanded with respect to Nₖ. If the answer is no, the flow continues at step 26 where the pullup function H_{N}_{ₖ} and the pulldown function L_{N}_{ₖ} of node Nₖ is calculated. The pullup function and pulldown functions in step 26 are determined in a similar fashion to the pullup and pulldown functions from step 21. Referring to FIG. 3, the pullup function H_{Q} is determined by the following equation: H_{Q}=\overline{X}·E. Similarly, the pulldown function for the circuit of FIG. 3 is calculated using the following equation: L_{Q}=X·E. The flow then continues from step 26 to step 27 where F is expanded with respect to Nₖ. The generalized version of the expansion equation can be expressed in the following equation:

(F·H_{N}_{ₖ}·\overline{L_{N}_{ₖ}})|_{N}_{ₖ}₌₁+(F·\overline{H_{N}_{ₖ}}·L_{N}_{ₖ})|_{N}_{ₖ₌₀}+F|_{N}_{ₖ}₌₁·F|_{N}_{ₖ}₋₀. Note that the expansion equation defines a reduction value of Nₖ for selected terms. Referring to FIG. 3, the expansion equation for the circuit of FIG. 3 can be expressed using the following equation: F·H_{Q}·\overline{L_{Q}}|_{Q=1}+F·\overline{H_{Q}}·L_{Q}|_{Q=0}+F|_{Q=1}·F|_{Q=0}. Still referring to FIG. 3, the next step is to substitute the specific Boolean functions for F, H_{Q} and L_{Q} in the expansion equation for the circuit of FIG. 3. The substitution results in the following equation:

$${( \overline{Q} \cdot \overline{X} E \cdot \overline{X E} ) \vert}_{{A = 0}_{Q = 1}} + ( \overline{Q} \cdot ( X + \overline{E} ) \cdot X E ) {\vert}_{{A = 0}_{Q = 0}} + \overline{Q} {\vert}_{{A = 0}_{Q = 1}} \cdot \overline{Q} {\vert}_{{A = 0}_{Q = 0}} = 0 + X E {\vert}_{{A = 0}_{Q = 0}} + 0 = X E {\vert}_{{A = 0}_{Q = 0}} .$$

Referring again to FIG. 2, step 27 now transitions to step 28 where the substitute expansion equation for term F is now substituted in equation G. The flow of FIG. 2 then proceeds from step 28 to decision diamond 42 where the question is asked, have all terms in G been selected. If all terms in G have been selected, the flow then proceeds to decision diamond 43 where the question is asked, have both Gbefore and Gafter been selected. If no, then the flow continues at step 32 where another one of Gbefore and Gafter are selected. If the answer is yes for decision diamond 43, then the flow continues at step 29 where the equation for G transition is set to be equal to Gbefore ANDed with Gafter, where Gbefore and Gafter are no longer expressed as a function of internal nodes N₁-N_{j.} From step 29 the flow then continues to step 30 where the values of S₁-Sᵢ which satisfy the G transition equation are determined. From step 30 the flow then ends at oval 11.

Referring again to decision diamond 42, if all the terms in G have not been selected, then the flow continues at step 24 where a previously unselected term F within G is selected. Referring to FIG. 2, the step 28 is implemented by substituting the expansion equation for the term F in equation G as follows:

$$Gbefore = \overline{C} {\vert}_{{A = 0}_{Q = 0}} + \overline{D} {\vert}_{{A = 0}_{Q = 0}} + X \cdot E {\vert}_{{A = 0}_{Q = 0}} .$$

Referring to FIG. 1, the flow then proceeds to decision diamond 42 where the question is asked, have all terms in G been selected for the circuit in FIG. 3. Since they have not (the term XE has not been selected), then the flow continues at step 24 where a term F is selected within G. In the example illustrated in FIG. 3, the term XE is selected during step 24. The term F can now be represented by the following equation: F=X·E|_{Q=O}^{A=O}. The flow then continues at decision diamond 40 where the question is asked, does F include any internal nodes N₁-Nⱼ. Note that when an output X is used to provide feedback within a circuit, that node X is also considered an internal node as well as the output. In the case of the circuit illustrated in FIG. 3, decision diamond 42 proceeds with a yes to step 25 where an internal node X is selected. Although node X is also the output, node X provides feedback to the circuit and is thus also considered an internal node. The flow then continues with decision diamond 41 where the question is asked, has F been expanded with respect to X. Since the answer is no, the flow continues at step 26 where the pullup function H_{X} and the pulldown function L_{X} are calculated. H_{X}=A·\overline{B}+C·(\overline{D}+\overline{Q})=A\overline{B}+C·\overline{D}+C·\overline{Q}, L_{X}=A·B+C·D·Q. The flow then proceeds to step 27 where F is expanded with respect to X. For the circuit illustrated in FIG. 3 the expansion equation can be written as follows:

$$( X E \cdot {H}_{X} \cdot \overline{{L}_{X}} ) {\vert}_{{A = 0}_{{Q = 0}_{X = 1}}} + ( X E \cdot \overline{{H}_{X}} \cdot {L}_{X} ) {\vert}_{{A = 0}_{{Q = 0}_{X = 0}}} + X E {\vert}_{{A = 0}_{{Q = 0}_{X = 1}}} \cdot X E {\vert}_{{A = 0}_{{Q = 0}_{X = 0}}} = E \cdot ( A \overline{B} + C \overline{D} + C \overline{Q} ) \overline{( A B + C D Q )} {\vert}_{{A = 0}_{{Q = 0}_{X = 1}}} + 0 + 0 = E C \overline{D} {\vert}_{{A = 0}_{{Q = 0}_{X = }}} + E C \overline{Q} {\vert}_{{A = 0}_{{Q = 0}_{X = 1}}}$$

. The flow then continues at step 28 where the expansion equation is substituted for term F in equation G as follows:

$$Gbefore = \overline{C} {\vert}_{{A = 0}_{{Q = 0}_{X = 1}}} + \overline{D} {\vert}_{{A = 0}_{{Q = 0}_{X = 1}}} + E C \overline{D} {\vert}_{{A = 0}_{{Q = 0}_{X = 1}}} + E C \overline{Q} {\vert}_{{A = 0}_{{Q = 0}_{X = 1}}} .$$

The flow then continues at decision diamond 42. Since all the terms in G have not yet been selected, the flow continues at step 24. For step 24 the following term is now selected

$$F = E C \overline{Q} {\vert}_{{A = 0}_{{Q = 0}_{X = 1}}} .$$

The flow then continues to decision diamond 40 where the question is asked, does F include any internal nodes N₁-Nⱼ. Since F includes an internal node Q, the flow continues with step 25 where an internal node Q is selected. The flow continues at decision diamond 41 where the question is asked, has F been expanded with respect to Q. Since the answer is yes, the flow continues at step 31 where the reduction value of Nₖ (in this case Q) is substituted in term F within equation G. After substitution, the equation for term F will be as follows: F=EC. The flow then continues at decision diamond 42 where the question is asked, have all terms in G been selected. Since for the example as illustrated in FIG. 3 all terms in G have not been selected, processing will continue at step 24. Eventually, processing for the circuit illustrated in FIG. 3 will complete at the ending oval 11. Note that only selected equations for selected steps within the flow of FIG. 1 and FIG. 2 have been illustrated for the circuit of FIG. 3 in order to better describe how the methodology may be used for a particular electrical circuit. One of skill in the art would understand how to apply the flow of FIG. 1 and FIG. 2 to other portions of the circuit illustrated in FIG. 3 in order to determine the switching vectors S₁-Sᵢ which satisfy the G transition equation. Note that the flow illustrated in FIG. 1 and FIG. 2 may be used for any type of electrical circuit. The circuit of FIG. 3 was illustrated as just one possible example. Note that the methodology illustrated in FIG. 1 and FIG. 2 may be used in any type of circuit analysis tools. For example, the present invention may be used as part of a timing analysis tool, a signal integrity analysis tool, a power consumption tool, a cell/circuit characterization tool, a circuit optimization tool, an electrical rule checking tool, or any other type of circuit analysis tool. Note that G transition is a reduced transition function. Note that switching input A may also be referred to as a transitioning input. Note that the present invention is also useful for debugging tools. Also, the present invention may also be used as part of an automatic test pattern generation tool.

Although the invention has been described with respect to specific conductivity types or polarity of potentials, skilled artisans appreciated that conductivity types and polarities of potentials may be reversed.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A method for generating a switching vector comprising:
providing a circuit having a transitioning input which receives a predetermined input transition, side inputs which assume side states, an output which provides a predetermined output transition in response to the predetermined input transition and the side states, and an internal node, wherein the internal node is at least one of a node located within a feedback path of the circuit and a node capable of assuming a first state, a second state, and a third state;
generating a Boolean transition function which represents the side states of the side inputs that cause the predetermined output transition to occur; and
determining the switching vector which satisfies the Boolean transition function.

2. The method of claim 1, wherein generating the Boolean transition function comprises:
generating a before transition function and an after transition function corresponding to the predetermined input transition and predetermined output transition;
selecting a first term within one of the before transition function or the after transition function, wherein the first term is expressed as a function of the internal node;
expanding the first term with respect to the internal node to obtain an expansion equation; and
using the expansion equation to generate the Boolean transition function.

3. The method of claim 2, wherein generating the Boolean transition function further comprises substituting the first term with the expansion equation.

4. The method of claim 3, wherein the expansion equation defines a reduction value for the internal node.

5. The method of claim 4, wherein generating the Boolean transition function further comprises:
selecting a second term within one of the before transition function or the after transition function, wherein the second term is expressed as a function of the internal node; and
substituting the reduction value for the internal node in the second term.

6. The method of claim 3, wherein the internal node is capable of assuming the first state, the second state, and the third state, the third state being a different state from the first state and the second state and wherein the expansion equation comprises:
a first term corresponding to the internal node assuming the first state;
a second term corresponding to the internal node assuming the second state; and
a third term corresponding to the internal node assuming the third state.

7. The method of claim 6, wherein the first state comprises logic high state, the second state comprises a logic low state, and the third state comprises at least one of an unknown state, a high impedance state, and a short circuit state.

8. The method of claim 3, wherein the circuit includes a second internal node, wherein the second internal node is at least one of a node located within a feedback path of the circuit and a node capable of assuming a first state, a second state, and a third state, and wherein generating the Boolean transition function further comprises:
selecting a second term within one of the before transition function or the after transition function, wherein the first term is expressed as a function of the second internal node;
expanding the second term with respect to the second internal node to obtain an expansion equation; and
substituting the second term with the expansion equation.

9. The method of claim 3, wherein when the expansion equation is satisfied, the first term is satisfied.

10. The method of claim 2, wherein the output and the internal node is a same node.

11. The method of claim 2, wherein the internal node is located within the feedback path of the circuit.

12. The method of claim 2, wherein the internal node is capable of assuming the first state, the second state, and the third state.

13. The method of claim 2, wherein the internal node is located within the feedback path of the circuit and is capable of assuming the first state, the second state, and the third state.

14. A method for generating a set of switching vectors comprising:
providing a circuit having a transitioning input which receives a predetermined input transition, side inputs which assume side states, an output which provides a predetermined output transition in response to the predetermined input transition and the side states, and a plurality of internal nodes, wherein each of the plurality of internal nodes is at least one of a node located within a feedback path of the circuit and a node capable of assuming a first state, a second state, and a third state; and
determining the set of switching vectors corresponding to the side states which results in the predetermined output transition, wherein the set of switching vectors is a subset of a full enumeration of all side states for the circuit.

15. The method of claim 14, where the set of switching vectors include only those switching vectors that result in the predetermined output transition.

16. The method of claim 14, wherein determining the set of switching vectors comprises:
generating a transition function corresponding to the predetermined input transition and predetermined output transition;
selecting a first term within the transition function, wherein the first term is expressed as a function of at least one internal node of the plurality of internal nodes;
expanding the first term with respect to the at least one internal node to obtain an expansion equation; and
using the expansion equation to reduce the transition function with respect to the at least one internal node to obtain a reduced transition function.

17. The method of claim 16, wherein the reduced transition function is not expressed as a function of any of the plurality of internal nodes.

18. The method of claim 16, wherein the set of switching vectors satisfies the reduced transition function.

19. The method of claim 16, wherein the expansion equation defines a reduction value for the at least one internal node, the method further comprising:
selecting a second term within the transition function, wherein the second term is expressed as a function of the at least one internal node; and
substituting the reduction value for the at least one internal node in the second term.

20. The method of claim 16, wherein the at least one internal node is capable of assuming the first state, the second state, and the third state, each of the first, second, and third state being a different state, and wherein the expansion equation comprises:
a first term corresponding to the at least one internal node assuming the first state;
a second term corresponding to the at least one internal node assuming the second state; and
a third term corresponding to the at least one internal node assuming the third state.

21. The method of claim 20, wherein the first state comprises logic high state, the second state comprises a logic low state, and the third state comprises at least one of an unknown state, a high impedance state, and a short circuit state.

22. A switching vector generator stored via at least one computer readable medium, the switching vector generator comprising:
a first set of instructions for receiving a circuit having a transitioning input which receives a predetermined input transition, side inputs which assume side states, an output which provides a predetermined output transition in response to the predetermined input transition and the side states, and an internal node, wherein the internal node is at least one of a node located within a feedback path of the circuit and a node capable of assuming a first state, a second state, and a third state;
a second set of instructions for generating a Boolean transition function which represents the side states of the side inputs that cause the predetermined output transition to occur; and
a third set of instructions for determining the switching vector which satisfies the Boolean transition function.

23. The switching vector generator of claim 22, further comprising:
a fourth set of instructions for generating a before transition function and an after transition function corresponding to the predetermined input transition and predetermined output transition;
a fifth set of instructions for selecting a first term within one of the before transition function or the after transition function, wherein the first term is expressed as a function of the internal node;
a sixth set of instructions for expanding the first term with respect to the internal node to obtain an expansion equation; and
a seventh set of instructions for using the expansion equation to generate the Boolean transition function.

24. The switching vector generator of claim 23, further comprising an eighth set of instructions for substituting the first term with the expansion equation.

25. The switching vector generator of claim 24, wherein the expansion equation defines a reduction value for the internal node.

26. The switching vector generator of claim 25, further comprising:
a ninth set of instructions for selecting a second term within one of the before transition function or the after transition function, wherein the second term is expressed as a function of the internal node; and
a tenth set of instructions for substituting the reduction value for the internal node in the second term.

27. The switching vector generator of claim 24, wherein the internal node is capable of assuming the first state, the second state, and the third state, the third state being a different state from the first state and the second state and wherein the expansion equation comprises:
a first term corresponding to the internal node assuming the first state;
a second term corresponding to the internal node assuming the second state; and
a third term corresponding to the internal node assuming the third state.

28. The switching vector generator of claim 27, wherein the first state comprises logic high state, the second state comprises a logic low state, and the third state comprises at least one of an unknown state, a high impedance state, and a short circuit state.

29. A switching vector generator stored via at least one computer readable medium, the switching vector generator comprising:
a first set of instructions for receiving a circuit having a transitioning input which receives a predetermined input transition, side inputs which assume side states, an output which provides a predetermined output transition in response to the predetermined input transition and the side states, and a plurality of internal nodes, wherein each of the plurality of internal nodes is at least one of a node located within a feedback path of the circuit and a node capable of assuming a first state, a second state, and a third state; and
a second set of instructions for determining the set of switching vectors corresponding to the side states which results in the predetermined output transition, wherein the set of switching vectors is a subset of a full enumeration of all side states for the circuit.

30. The switching vector generator of claim 29, further comprising:
a third set of instructions for generating a transition function corresponding to the predetermined input transition and predetermined output transition;
a fourth set of instructions for selecting a first term within the transition function, wherein the first term is expressed as a function of at least one internal node of the plurality of internal nodes;
a fifth set of instructions for expanding the first term with respect to the at least one internal node to obtain an expansion equation; and
a sixth set of instructions for using the expansion equation to reduce the transition function with respect to the at least one internal node to obtain a reduced transition function.

31. The switching vector generator of claim 30, wherein the expansion equation defines a reduction value for the at least one internal node, the switching vector generator further comprising:
a seventh set of instructions for selecting a second term within the transition function, wherein the second term is expressed as a function of the at least one internal node; and
an eighth set of instructions for substituting the reduction value for the at least one internal node in the second term.

32. The switching vector generator of claim 30, wherein the internal node is capable of assuming the first state, the second state, and the third state, each of the first, second, and third state being a different state, and wherein the expansion equation comprises:
a first term corresponding to the at least one internal node assuming the first state;
a second term corresponding to the at least one internal node assuming the second state; and
a third term corresponding to the at least one internal node assuming the third state.

33. The switching vector generator of claim 32, wherein the first state comprises logic high state, the second state comprises a logic low state, and the third state comprises at least one of an unknown state, a high impedance state, and a short circuit state.
